(19) United States
(12) Patent Application Publication
(10) Pub. No.: US 2016/0250755 A1
(43) Pub. Date: Sep. 1, 2016

(54) Handling System for Different Component Variants and Method for Operating a Handling System

(71) Applicant: DAIMLER AG, Stuttgart (DE)

(72) Inventors: Stefan LEO, Erpolz (DE); Heiko THALER, Sindelfingen (DE)

(73) Assignee: Daimler AG, Stuttgart (DE)

(21) Appl. No.: 15/028,389

(22) PCT Filed: Sep. 20, 2014
(86) PCT No.: PCT/EP2014/002558

§ 371 Date: Apr. 8, 2016

(30) Foreign Application Priority Data
Oct. 10, 2013 (DE) 10 2013 016 820.1

(51) Int. Cl. B25J 15/00

(52) U.S. Cl. CPC B25J 15/0061; B25J 15/009

(57) ABSTRACT

A handling system for handling different component variants, in particular sheet metal component variants, is disclosed. The handling system has a gripping tool including several adjustable fasteners, by which the different component variants can be fixed in a predetermined position on the gripping tool. The gripping tool includes several adjustable abutment mechanisms for placement on the different component variants. The abutment mechanisms each include a plurality of pin-like elements which can be adjusted in their longitudinal direction into different positions for placement on the different component variants. A method for operating a handling system for different component variants is also disclosed.

### BACKGROUND AND SUMMARY OF THE INVENTION

The invention relates to a handling system for different component variants and to a method for operating such a handling system.

A generic handling system for different component variants is shown in DE 10 2010 038 702 A1. The handling system comprises a robot-controlled gripper, which can be employed for a large number of different vehicle tailgate variants. The gripper comprises a frame with several clamping mechanisms that can be moved vertically and horizontally on the frame so that the clamping mechanisms can be adjusted to each tailgate variant to be manipulated.

In addition, a handling system with a gripping device and several adjustable suction grippers is described in EP 1 256 421 A1. The suction grippers are used to fix different component variants in a predetermined position on the gripping device. The gripping device additionally comprises several adjustable abutment mechanisms for placement on the different component variants.

The object of the present invention is to provide a handling system as well as a method for operating a handling system of the aforementioned kind, by means of which a large number of different component variants can be manipulated in an improved manner.

The handling system of the invention for different component variants, in particular sheet metal component variants, comprises a gripping tool that comprises several adjustable fasteners by means of which the different component variants can be fixed on the gripping tool in a predetermined position. The gripping tool additionally comprises several adjustable abutment mechanisms for placement on the different component variants. According to the invention, provision is made such that the abutment mechanisms are each equipped with a plurality of pin-like elements, which can be adjusted in their longitudinal. direction into different positions for placement on the different component variants. In other words, the abutment mechanisms each comprise a set of several pin-like elements, which can each be adjusted into different positions in their longitudinal direction in order to form an at least essentially form-negative contour to the respective component area of the component variant about to be manipulated so that the component variant about to be manipulated can be braced in a particularly secure and reliable manner. For this purpose, the pin-like elements are each preferably positioned with corresponding end faces against corresponding areas of the component variants to be manipulated. The pin-like elements can be arranged side by side, for example, in which case the end faces of the pin-like elements can form an almost gapless contour, in which case the corresponding component variant, in certain areas, can be virtually flatly braced.

By virtue of the adjustability of the abutment mechanisms, the latter can be adapted to the respectively different shapes of each of the component variants to be manipulated so that during the manipulation of the different component variants, the abutment mechanisms are able to fit snugly against the latter, In other words, the abutment mechanisms can each be adjusted in a form-negative manner to corresponding areas of the respective component variants to be manipulated, on which the abutment mechanisms are placed. With the handling system of the invention, very diverse component variants with very diverse geometries can be braced in a precise manner by means of the adjustable abutment mechanisms, thus permitting a particularly stable manipulation of the respective component variants.

In an advantageous embodiment of the invention, provision is made such that the pin-like elements can be adjusted to and fixed in respective stop positions, or adjusted and fixed steplessly. If the pin elements can be steplessly adjusted to and fixed in respective stop positions, then the latter can be adapted or adjusted in accordance with the component variant about to be manipulated in a particularly expedient manner, since the pin elements lock into the respective stop positions. If on the other hand, the pin elements can be steplessly adjusted and fixed, then the latter can be adapted with great precision to corresponding component geometries of the respective component variants to be manipulated such that a particularly good bracing effect is achievable for manipulating the component variants. The adjustment and fixing of the pin elements can either be controlled manually or by suitable drive units.

In another advantageous embodiment of the invention, provision is made such that the abutment mechanisms can be adjusted in translation in at least one spatial direction. The abutment mechanisms can thus be positioned in accordance with the component geometry of the component variant about to be manipulated such that a particularly good bracing effect is achievable during the manipulation of the corresponding component variant. The abutment mechanisms can also be adjusted in such a way that some of the abutment mechanisms form respective stops in any spatial direction for the component variant to he manipulated. The component variant fixed on the gripping tool can thus be prevented from shifting out of place, for example.

Another advantageous embodiment of the invention makes provision such that the fasteners comprise respective fastening elements which can be moved to and from a release position for releasing the respective component variants and a fastening position for fixing the respective component variants on the fasteners. The fasteners can be configured essentially in the form of mandrels, for example, which can be introduced into recesses provided on the respective component variant for this purpose. The fastening elements can be configured as so-called hook clamps, which are collapsed as they are being introduced into the corresponding recesses and once suitably positioned, they can then be extended so that the component variant to be manipulated can be securely fixed on the fastener.

In another advantageous embodiment of the invention, provision is made such that the handling system comprises a robot on which the gripping tool is arranged. The gripping tool can thus be moved as well as controlled in a particularly expedient manner by means of the robot, in order to perform corresponding manipulation tasks automatically. For example, the abutment mechanisms and the fasteners can be controlled by the robot.

Another advantageous embodiment of the invention makes provision such that the handling system comprises at least one stationary receiving device for receiving the different component variants. Thus each of the component variants to be manipulated can be set or rather positioned on the stationary receiving device so that corresponding assembly steps or manufacturing steps, for example, can be performed on the component variant.

According to another advantageous embodiment of the invention, provision is made such that the stationary receiving device comprises another gripping tool, Which comprises several of the adjustable fasteners by means of which the different component variants can be fixed on the other gripping tool. Thus the component variant about to be manipulated can be positioned on the receiving device and then fixed securely on the receiving device by means of the other gripping tool of the receiving device. Conversely, the other gripping tool of the stationary receiving device can first be used to position the corresponding component variant precisely in relation to the stationary receiving device and fix it thereon, in which case the gripping tool preferably arranged on the robot can then grip the component variant in a particularly expedient and precise fashion.

Another advantageous embodiment of the invention makes provision such that the other gripping tool comprises several of the abutment mechanisms for placement on the different component variants. The component variant just positioned or rather set on the receiving device can thus be especially well braced by the corresponding abutment mechanisms so that damage to or undesired distortions of the component variant can be prevented.

The method of the invention for operating a handling system for different component variants, in particular sheet metal component variants, comprises the following steps:
Positioning of respective fasteners of a gripping tool of the handling system in accordance with one of the component variants to be manipulated;
Positioning of the gripping tool in relation to the component variant;
Fixing of the component variant in a predetermined position on the gripping tool by means of the fasteners.

For improved manipulation of the respective component variants, according to the invention provision is made such that several abutment mechanisms of the gripping tool are positioned in accordance with the component variant and then, during the positioning of the gripping tool in relation to the component variant, the abutment mechanisms are placed on the component variant. Advantageous embodiments of the handling system of the invention are thus to be deemed advantageous embodiments of the method of the invention.

Other advantages, features, and details of the invention will emerge from the following description of preferred exemplary embodiments as well as by referring to the drawings. The features and feature combinations mentioned previously in the description as well as the features and feature combinations mentioned in the following figures description and/or shown just in the figures can not only be used in the respectively given combination, but also in other combinations or alone, without exceeding the scope of the invention.

### BRIEF DESCRIPTION OF THE DRAWINGS

FIG. 1 is a perspective view of a handling system with a robot, on which a gripping tool for gripping and fixing different component variants is arranged, wherein one of the component variants is arranged on a stationary receiving device;

FIG. 2 is a perspective detailed view of the gripping tool, which comprises two mandrel-like fasteners as well as a plurality of abutment mechanisms; and

FIG. 3 is a perspective detailed view of the handling system, wherein the component variant set on the stationary receiving device is being gripped by means of the gripping tool arranged on the robot.

### DETAILED DESCRIPTION OF THE DRAWINGS

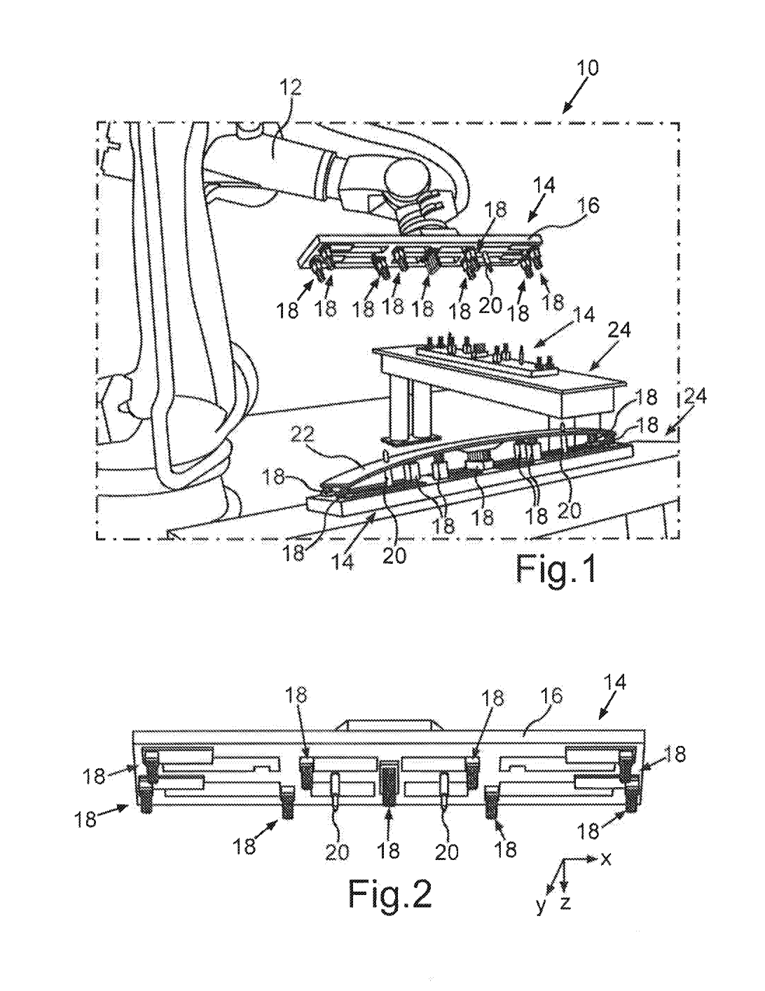

A handling system designated in its entirety by 10 is shown in a perspective view in FIG. 1. The handling system 10 comprises a robot 12 on which a gripping tool 14 is arranged. The gripping tool 14 comprises a frame element 16, on which a plurality of abutment mechanisms 18 and two fasteners 20 are arranged.

The gripping tool 14 is configured for gripping and manipulating a plurality of different components variants 22, wherein only one of the component variants 22 is shown in the present case. The different component variants 22 can be, for example, different, preferably rigid sheet metal component variants in the form of vehicle hoods, tailgates, doors, and the like. The abutment mechanisms 18 and the fasteners 20 of the gripping tool 14 are adjustably configured so that they can be adapted for gripping and manipulating very diverse component variants 22.

The handling system 10 additionally comprises two stationary receiving devices 24 for receiving the different component variants 22. The stationary receiving devices 24 are designed such that the component variants 22 can be gripped by the receiving devices and/or repositioned thereon, respectively, with precision.

In the case shown here, the two stationary receiving devices comprise additional identically constructed gripping tools 14, by means of which the different component variants 22 can be received, braced, and fixed. As an alternative, it is also possible for the stationary receiving devices 24 to have in part differently configured gripping tools, by means of which the corresponding component variants 22 can be received, braced, and fixed.

One of the gripping tools 14 is illustrated in a perspective detailed view in FIG. 2. The abutment mechanisms 18 and the two mandrel-like fasteners 20 can be adjusted in translation in the longitudinal direction x, the transverse direction y, and the height direction z of the gripping tool 14. It is also possible for the fasteners 20 and/or the abutment mechanisms 18 to be only partially adjustable in the longitudinal direction x, the transverse direction y, and the height direction z of the gripping tool 14. The abutment mechanisms 18 are primarily used for placement on each component variant 22 to be manipulated such that the latter is stably braced as it is being manipulated.

The positioning of the abutment mechanisms 18 and the fasteners 20 can thus be adapted in accordance with a specific geometry of the component variant 22 about to be manipulated. It is thus possible to fix each of the different component variants 22 in a predetermined position on the gripping tool 14, preferably centered relative to the latter, and brace the component variant 22 in question by means of the abutment mechanisms 18 placed thereon.

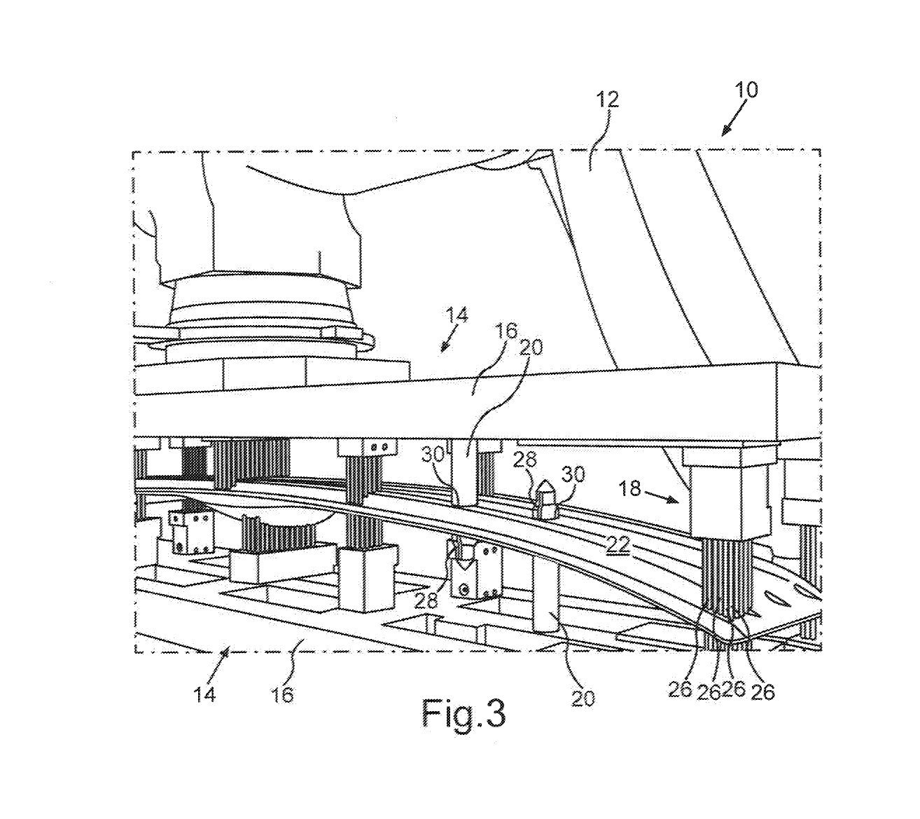

A portion of the handling system 10 is shown in a perspective detailed view in FIG. 3. For the sake of clarity, in the present case not all fasteners 20 and abutment mechanisms 18 are designated with reference signs. By means of the robot 12, the gripping tool 14 has just been positioned relative to the component variant 22 to be manipulated. The component variant 22 is initially still held on the gripping tool 14 mounted on the stationary receiving device 24. Before the gripping tool 14 mounted on the robot 12 is placed and suitably positioned on the component variant 22 to be manipulated, the fasteners 20 and the abutment mechanisms 18 are positioned in accordance with the geometry of the component variant 22 to be manipulated.

As can be discerned, the abutment mechanisms 18 each comprise a plurality of pin-like elements 26, which can be adjusted in their longitudinal direction (i.e., in the height direction z of the gripping tool 14 in the present case) into different positions for placement on the different component variants 22. The pin elements 26 can either be formed to be adjustable and fixable in respective stop positions or as an alternative, also formed to be steplessly adjustable and fixable. By virtue of the adjustability of the pin elements 26, with the respective abutment mechanisms 18 it is thus possible to form an essentially form negative contour which can be positioned against corresponding areas of each of the component variants 22 to be manipulated.

Hence before the component variant 22 is gripped by means of the gripping tool 14 mounted on the robot 12, the abutment mechanisms 18 are first suitably positioned in translation in the longitudinal direction x and/or in the transverse direction y of the gripping tool 14, wherein the pin-like elements 26, according to the respective component variant 22 to be manipulated, are likewise extended or retracted accordingly.

Once the appropriate component-specific required settings have been made to the fasteners 20 and to the abutment mechanisms 18, the gripping tool 14 mounted on the robot 12 is placed on the component variant 22 to be received or gripped, respectively. In this process, the fasteners 20 pass through corresponding openings 30 of the component variant 22. Once the pita-like elements 26 are placed on or fitted snugly against the component variant 22, corresponding fastening elements 28, which are arranged on the mandrel-like fasteners 20, are moved from a retracted release position for releasing the component variant 22 into the extended fastening position shown here for fixing the component variant 22 on the fasteners 20 in question. The fastening elements 28 can be configured as so-called hook clamps, for example, which can be retracted into and extended from the mandrel-like fasteners 20.

Once the component variant 22 to be gripped has been fixed, by means of the fasteners 20 or by means of the respective fastening elements 28, on the gripping tool 14 mounted on the robot 12, corresponding fastening elements 28 of the fasteners 20, which are arranged on the gripping tool 14, which is in turn arranged on the stationary receiving device 24, are released so that the component variant 22 is released from the stationary receiving device 24, The gripped component variant 22 can then be removed by means of the robot 12 from the stationary receiving device 24 and arranged on, for example, another stationary receiving device 24.

The positioning or rather adjustment of the fasteners 20, the fastening elements 28, the abutment mechanisms 18, and the pin-like elements 28 can be effected automatically in accordance with each of the component variants 22 to be manipulated and the variant-specific geometries thereof by, for example, a control device (not illustrated here) of the handling system 10.

For setting the handling system 10 to a new component variant 22 and for the subsequent handling and defined placement of the new component variant 22, the following steps are carried out:
Positioning of several abutment mechanisms 18 of the gripping tool 14 of the handling system 10 in accordance with the component variant 22 to be manipulated;
Positioning of the gripping tool 14 in relation to the component variant 22, wherein the positioned abutment mechanisms 18 are placed on the component variant 22;
Fixing of the component variant 22 by means of the fasteners 20 in a predetermined position on the gripping tool 14 by closing and/or locking the fastening elements 28 in the gripper 14;
Handling/manipulation of the gripper 14 with the component variant 22;
Setting of the component variant 22 in the stationary and/or movable storage device 24;
Locking of the fastening elements 28 in the stationary and/or movable storage device 24;
Releasing of the fastening elements 28 in the gripper 14 of the component variant 22;
Pulling of the gripper 14 out of the component variant 22;
Optional: Adjustment of the fasteners 20 and/or fastening elements 28 for receiving another component variant 22.

The handling system 10 described herein thus makes it possible to use the same gripping tool 14 for very diverse component variants 22, wherein the respective component variants 22 in their respective variant-specific, three-dimensional configurations can be securely gripped and manipulated by the adjustable abutment mechanisms 18.

1-9. (canceled)

10. A handling system for handling different component variants, comprising:
a first gripping tool, wherein the first gripping tool includes:
a plurality of adjustable fasteners, wherein the different component variants are respectively fixable in a predetermined position on the first gripping tool by the plurality of adjustable fasteners; and
a plurality of adjustable abutment mechanisms, wherein the plurality of adjustable abutment mechanisms are placeable on the respective different component variants;
wherein the plurality of adjustable abutment mechanisms each include a plurality of pin-like elements which are adjustable in a longitudinal direction into different positions for placement on the respective different component variants.

11. The handling system according to claim 10, wherein the different component variants are sheet metal component variants.

12. The handling system according to claim 10, wherein the plurality of pin-like elements are adjustable and fixable in respective stop positions or are steplessly adjustable and fixable.

13. The handling system according to claim 10, wherein the plurality of adjustable abutment mechanisms are adjustable in translation in at least one spatial direction.

14. The handling system according to claim 10, wherein each of the plurality of adjustable fasteners includes a fastening element which is movable to and from a release position for releasing a respective different component variant and a fastening position for fixing the respective different component variant.

15. The handling system according to claim 10, wherein the handling system includes a robot on which the first gripping tool is disposed.

16. The handling system according to claim 10, wherein the handling system includes a stationary and/or a movable receiving device, wherein the different component variants are receivable on the receiving device.

17. The handling system according to claim 16, wherein the stationary and/or the movable receiving device includes a second gripping tool which includes a plurality of adjustable fasteners and wherein the different component variants are respectively fixable on the second gripping tool by the plurality of adjustable fasteners of the second gripping tool.

18. The handling system according to claim 17, wherein the second gripping tool includes a plurality of adjustable abutment mechanisms.

19. A method for operating a handling system for handling different component variants, comprising the steps of:
positioning of a plurality of adjustable fasteners of a gripping tool of the handling system in accordance with one of the different component variants to be manipulated;
positioning of the gripping tool in relation to the one of the different component variants;
positioning of a plurality of adjustable abutment mechanisms of the gripping tool in accordance with the one of the different component variants;
placing of the positioned plurality of adjustable abutment mechanisms on the one of the different component variants during the step of positioning of the gripping tool; and
fixing of the one of the different component variants by the plurality of adjustable fasteners in a predetermined position on the gripping tool.

20. The method according to claim 19, wherein the different component variants are sheet metal component variants.
